(19) United States
(12) Patent Application Publication
(10) Pub. No.: US 2025/0087992 A1
(43) Pub. Date: Mar. 13, 2025

(54) AUTOMATED TIGHTLY-STACKED PROTECTION COORDINATION

(71) Applicant: S&C Electric Company, Chicago, IL (US)

(72) Inventors: Farnaz Harirchi, Libertyville, IL (US); Gabrielle Madden, Chicago, IL (US); John French, Chicago, IL (US); Oleg Nazarov, Okemos, MI (US); Goran Djogo, Mount Prospect, IL (US); Yoav Sharon, Evanston, IL (US)

(73) Assignee: S&C Electric Company, Chicago, IL (US)

(21) Appl. No.: 18/789,747

(22) Filed: Jul. 31, 2024

Related U.S. Application Data
(60) Provisional application No. 63/516,988, filed on Aug. 1, 2023.

(51) Int. Cl. H02H 7/30; H02H 3/093

(52) U.S. Cl. CPC H02H 7/30; H02H 3/0935

(57) ABSTRACT

A system and method for providing fault protection and coordination between fault interrupting devices in a power distribution network. The method includes assigning a coordination number to each device depending on where the device is in the network and what other fault interrupting devices are downstream of the device, where the assigned coordination number to the device is equal to the largest coordination number of any downstream device plus one. The method further includes calculating a TCC curve for the devices having the lowest coordination number based on a TCC curve of a fuse-like device downstream of the device and tolerances of the device. The method then sequentially calculates a TCC curve for the devices having the next lowest coordination number based on the TCC curves of the devices having a lower coordination number and tolerances of the device until all of the devices have a TCC curve.

### CROSS-REFERENCE TO RELATED APPLICATION

This application claims the benefit of priority from the U.S. Provisional Application No. 63/516,988, filed on Aug. 1, 2023, the disclosure of which is hereby expressly incorporated herein by reference for all purposes.

### BACKGROUND

### Field

The present disclosure relates generally to a system and method for providing fault protection and coordination between fault interrupting devices in a power distribution network.

### Discussion of the Related Art

An electrical power distribution network, often referred to as an electrical grid, typically includes power generation plants each having power generators, such as gas turbines, nuclear reactors, coal-fired generators, hydro-electric dams, etc. The power plants provide power at a variety of medium voltages that are then stepped up by transformers to a high voltage AC signal to be connected to high voltage transmission lines that deliver electrical power to substations typically located within a community, where the voltage is stepped down to a medium voltage for distribution. The substations provide the medium voltage power to three-phase feeders including three single-phase feeder lines that carry the same current but are 120° apart in phase. three-phase and/or single-phase lateral lines are tapped off of the feeder that provide the medium voltage to various distribution transformers, where the voltage is stepped down to a low voltage and is provided to loads, such as homes, businesses, etc.

Periodically, faults occur in the distribution network as a result of various things, such as animals touching the lines, lightning strikes, tree branches falling on the lines, vehicle collisions with utility poles, etc. Faults may create a short-circuit that increases the stress on the network, which may cause the current flow to significantly increase, for example, many times above the normal current, along the fault path. This amount of current causes the electrical lines to significantly heat up and possibly melt, and also could cause mechanical damage to various components in the network. These faults are often transient or intermittent faults as opposed to a persistent or bolted fault, where the thing that caused the fault is removed a short time after the fault occurs, for example, a lightning strike. In such cases, the distribution network will almost immediately begin operating normally after a brief disconnection from the source of power.

Traditionally, a fuse is employed as a primary overload protection device for protecting distribution transformers and other devices that has a certain rating so that the fuse will operate above a transformer inrush current, but below a transformer through fault protection withstand or damage curve. However, fuses often create an arc when they operate, which has obvious dangers and drawbacks.

Reclosers and other related devices that employ fault interrupting devices are often provided as protection devices on utility poles and other locations. These reclosers typically detect the current and/or voltage on the line to monitor current flow and have controls that indicate problems with the network circuit, such as detecting a high current fault event. If such a high fault current is detected the recloser is opened in response thereto, and then after a short delay is closed to determine whether the fault is a transient fault. If high fault current flows when the recloser is closed after opening, it is immediately re-opened. If the fault current is detected a second time, or multiple times, during subsequent opening and closing operations indicating a persistent fault, then the recloser remains open and it may drop out of its mounting or provide another form of indication that it is locked open, where the time between detection tests may increase after each test.

When a fault is detected, it is desirable that the first fault interrupting device upstream from the fault be opened as soon as possible so that the fault is quickly removed from the network to prevent damage to equipment, personal injury, fires, etc., and so that the loads upstream of that fault interrupting device are not disconnected from the power source and service is not interrupted to them. It is further desirable that if the first fault interrupting device upstream from the fault does not open for whatever reason, then a next fault interrupting device upstream from the fault is opened, and so on. In order to accomplish this, it is necessary that some type of communications or coordination protection scheme be employed in the network so that the desired fault interrupting device is opened in response to the fault.

One known protection scheme for this purpose is referred to in the art as a time-current characteristic (TCC) coordination scheme. Generally, for a TCC coordination scheme each fault interrupting device in a particular series of fault interrupting devices on a feeder is assigned a sliding TCC value that defines how fast the fault interrupting device will open in response to detecting a fault, where the TCC value is slower for lower currents and is faster for higher currents, and where the sliding value defines a TCC curve. TCC curves with sliding values are typically used in systems where protection consists of both fuses and relayed fault interrupting devices. In systems without fuses a definite-time TCC curve is more commonly used. As the fault interrupting devices are provided farther downstream from the source, they are given faster TCC values so that the first upstream fault interrupting device from a detected fault will open before a next up stream interrupting device from the fault, where the particular fault interrupting device will stop timing to its TCC value once a downstream fault interrupting device opens and the fault is removed. However, traditional TCC coordination schemes are limited in the number of fault interrupting devices a feeder can have because the TCC curves cannot be too close together in order for the coordination to be effective. In other words, the number of TCC curves that realistically can be provided is limited. Moreover, fault interrupting devices closer to the source need to operate relatively slowly.

Traditional TCC coordination schemes that employ predefined TCC curve shapes create a technical challenge that limits the total number of possible fault interrupting devices on a feeder. Specifically, coordinating multiple fault interrupting devices using traditional coordination schemes requires significant engineering effort or using optimization algorithms to choose the best TCC curve shape for each fault interrupting device and leads to long clearing times for upstream faults. Further, in traditional overcurrent coordination schemes, selecting the TCC curves requires a minimum tripping/melting time, as a function of current magnitude, of a given fault interrupting device to be greater than the maximum/total clearing time, also a function of current, of each downstream fault interrupting device. The minimum time is the smallest possible time that the fault interrupting device can send the open command to the device, and the maximum time is the maximum time from when the fault is initiated until the fault fully clears.

Typically, an additional coordination time interval is applied between two TCC curves. The selection of an appropriate TCC curve for each fault interrupting device requires a complex coordination study to be performed, which increases with each additional fault interrupting device placed on the feeder. More specifically, the engineer needs to supply the fuse curves, loading information, available fault current and tolerances for each fault interrupting device. The loading information is used to determine the pickup for each fault interrupting device. In addition, in traditional overcurrent coordination, for each fault interrupting device, the engineer also needs to determine the curve family, speed and time dial in order to coordinate with the downstream fuses and fault interrupting devices, which are derived through trial and error as there is no closed-form formula. This process is then repeated for each fault interrupting device.

### SUMMARY

The following discussion discloses and describes a system and method for providing fault protection and coordination between fault interrupting devices in a power distribution network, where the fault interrupting devices are operable to open to clear a fault. The method includes assigning a coordination number to each particular fault interrupting device that are not fuse-like devices depending on where the particular fault interrupting device is in the network and what other fault interrupting devices are downstream of the particular fault interrupting device, where the assigned coordination number to the particular fault interrupting device is equal to the largest coordination number of any downstream fault interrupting device plus one. The method further includes calculating a TCC curve for the fault interrupting devices having the lowest coordination number based on a TCC curve of a fuse-like device downstream of the fault interrupting device having the lowest coordination number and tolerances of the fault interrupting device having the lowest coordination number. The method then sequentially calculates a TCC curve for the fault interrupting devices having the next lowest coordination number based on the TCC curves of the fault interrupting devices having a lower coordination number and tolerances of the fault interrupting device having the next lowest coordination number until all of the fault interrupting devices having a coordination number have a TCC curve.

Additional features of the disclosure will become apparent from the following description and appended claims, taken in conjunction with the accompanying drawings.

### BRIEF DESCRIPTION OF THE DRAWINGS

FIG. 1 is a simplified schematic type diagram of an electrical power distribution network including digital fault interrupting devices;

FIG. 2 is a simplified schematic block diagram of a digital device;

FIG. 3 is a simplified schematic type diagram of another electrical power distribution network including digital fault interrupting devices;

FIG. 4 is a logarithmic graph with current in amps on the horizontal axis and time in seconds on the vertical axis showing TCC curves for a known curve-stacked coordination scheme of the devices shown in the network of FIG. 3;

FIG. 5 is a logarithmic graph with current in amps on the horizontal axis and time in seconds on the vertical axis showing TCC curves for an automated tightly-stacked coordination scheme of the devices shown in the network of FIG. 3;

FIG. 6 is a logarithmic graph with current in amps on the horizontal axis and time in seconds on the vertical axis showing TCC curves for an automated tightly-stacked coordination scheme with speed improvement of the devices shown in the network of FIG. 3;

FIG. 7 is a logarithmic graph with current in amps on the horizontal axis and time in seconds on the vertical axis showing TCC curves for a known communications enhanced curve-stacked coordination scheme of the devices shown in the network of FIG. 3; and

FIG. 8 is a logarithmic graph with current in amps on the horizontal axis and time in seconds on the vertical axis showing TCC curves for an automated communications enhanced tightly-stacked coordination scheme of the devices shown in the network of FIG. 3.

### DETAILED DESCRIPTION OF THE EMBODIMENTS

The following discussion of the embodiments of the disclosure directed to a system and method for providing fault protection and coordination between fault interrupting devices in a power distribution network, where the method assigns a coordination number to each device based on its location in the network, is merely exemplary in nature, and is in no way intended to limit the invention or its applications or uses.

This disclosure proposes a fault protection and coordination scheme for a power distribution network, referred to herein as an automated tightly-stacked coordination scheme, that drastically reduces engineering design effort by not requiring predefined TCC curves and optimization algorithms, allows for greater segmentation, and increases the speed of fault clearing operations. A distribution engineer only needs to input a few generally known parameters in addition to the device specific information predetermined by the digital device, such as tolerances. The engineer must assign a coordination number, described in detail below, and define the fuse characteristic in terms of pickup current and speed of the largest fuse-like device downstream of the specific device to each fault interrupting device. The TCC curve for the device is then automatically defined as a closed-form formula, where no trial and error is required. This makes the protection and coordination scheme more amenable to automation where all of the necessary information can be initially extracted from a digitally stored feeder model, which gets updated whenever the feeder topology changes, for example, due to switching or when new fault interrupting devices are added.

It is noted that fault interrupting devices as described herein come in two categories, namely, devices that operate on one or more static sets of TCC curves, such as fuses or electromechanical relays, sometimes referred to herein as fuse-like devices, and microprocessor-based fault interrupting devices that can implement any arbitrary TCC curve shape, sometimes referred to herein as digital devices. The proposed automated tightly-stacked coordination scheme only applies to digital devices. For each digital device participating in the scheme, several parameters are set in the device controller. The manner of setting these parameters is inconsequential and options could include setting the parameters locally, remotely or at the factory. For simplification of description, it is assumed that all of the digital devices are participating in the automated tightly-stacked coordination scheme. However, the scheme can easily be generalized where some of the digital devices do not participate in the scheme and continue to operate with predefined TCC curves as fuse-like devices.

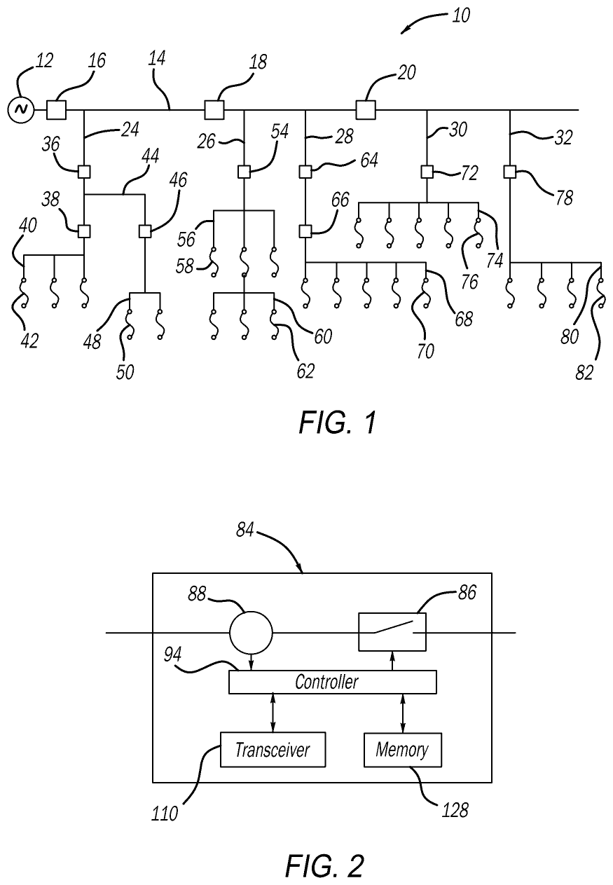

FIG. 1 is a simplified schematic type diagram of an electrical power distribution network 10. The network 10 includes an AC source 12 of power, such as a substation, that provides power on a three-phase feeder 14. A circuit breaker 16 is provided on the feeder 14 proximate the source 12, and two reclosers 18 and 20 are provided on the feeder 14 downstream of the circuit breaker 16. One or two-phase laterals 24, 26, 28, 30 and 32 are tapped off of the feeder 14 at various locations. Two reclosers 36 and 38 are provided on the lateral 24 and distribution lines 40 each including a fuse 42 are tapped off of the lateral 24. A lateral 44 including a recloser 46 is tapped off of the lateral 24 and distribution lines 48 each including a fuse 50 are tapped off of the lateral 44. A recloser 54 is provided on the lateral 26 and distribution lines 56 each including a fuse 58 are tapped off of the lateral 26. distribution lines 60 each including a fuse 62 are tapped off of one of the distribution lines 56. Two reclosers 64 and 66 are provided on the lateral 28 and distribution lines 68 each including a fuse 70 are tapped off of the lateral 28. A recloser 72 is provided on the lateral 30 and distribution lines 74 each including a fuse 76 are tapped off of the lateral 30. A recloser 78 is provided on the lateral 32 and distribution lines 80 each including a fuse 82 are tapped off of the lateral 32.

A coordination number N is assigned to each digital fault interrupting device that is equal to the largest coordination number of any downstream fault interrupting devices plus 1. If there are no downstream digital interrupting devices, i.e., only fuses, the coordination number N of the device is 1. For the network 10, the reclosers 38, 46, 54, 66, 72 and 78 are assigned coordination number 1, the reclosers 20, 36 and 64 are assigned coordination number 2, the recloser 18 is assigned coordination number 3 and the circuit breaker 16 is assigned coordination number 4. An ideal application of the automated tightly-stacked coordination scheme would cause the coordination numbers N to be automatically assigned to each device, for example, by utilizing geographic information system (GIS) data. If the fault interrupting devices can communicate with each other changes in system configuration, the coordination numbers N could be adaptively updated to match the current system configuration.

Each of the digital devices calculates the TCC curves of all of the digital devices as discussed herein. FIG. 2 is a simplified schematic block diagram of a digital device 84 intended to be a non-limiting general representation of any one of the reclosers or other digital devices discussed herein showing elements to perform the calculations. The device 84 includes a switch 86, voltage/current sensors 88, a controller 94, a memory 128, and a transceiver 110, where the memory 128 stores executable code to perform the various calculations discussed herein.

The automated tightly-stacked coordination scheme starts by coordinating all of the devices numbered 1. For each device with coordination number 1, its TCC curve is calculated based on the TCC curve of the largest fuse that is downstream of the device and the tolerances of the device, where the tolerances are discussed below. Next, all of the devices with coordination number 2 are coordinated. For each device with coordination number 2, its TCC curve is calculated based on the largest fuse's TCC curve between itself and the next digital device, the TCC curve of its downstream digital device and the tolerances of the digital device. The process continues for the devices with coordination number 3 and up until the device with coordination number N, here number 4. This scheme also has a predetermined time T_{space}, such as 5 ms, that acts as a buffer between the device's TCC curves.

Each digital fault interrupting device has a known current sensor tolerance ±I_{% tol} expressed as a percentage of the true current, a known time tolerance ±T_{% tol} expressed as a percentage of a nominal clearing time tₙₒₘ(I) for a digital device to send a trip command when measuring current I, a known fixed time tolerance ±T_{fix-tol} expressed in seconds, and a known maximum interruption/arcing time Tₘₐₓ₋ᵢₙₜ expressed in seconds.

The minimum measured current Iₘₑₐₛ₋ₘᵢₙ for a given true current is:

$${I}_{meas - min} = I ( 1 - {1}_{\% tol} ) . \qquad ( 1 )$$

Similarly, the maximum measured current Iₘₑₐₛ₋ₘₐₓ for a given true current is:

$${I}_{meas - max} = I ( 1 + {1}_{\% tol} ) . \qquad ( 2 )$$

The minimum trip time tₘᵢₙ(I) by which the fault is fully interrupted by the digital device is:

$${t}_{min} ( I ) = {t}_{n o m} ( {I}_{meas - max} ) ( 1 - {T}_{\% tol} ) - {T}_{fix - tol} . \qquad ( 3 )$$

Similarly, the maximum clearing time tₘₐₓ(I) by which the fault is fully interrupted by the digital device is:

$${t}_{max} ( I ) = {t}_{n o m} ( {I}_{meas - min} ) ( 1 + {T}_{\% tol} ) + {T}_{fix - tol} + {T}_{max - int} . \qquad ( 4 )$$

To ensure that every upstream digital device operates after all of the downstream devices, the minimum trip time tₘᵢₙ(I) for each device must be greater than the maximum clearing time tₘₐₓ(I) of every downstream digital device for a given current, even if the downstream digital device operates at the slowest extent of its tolerances, which means:

$${t}_{min , N} ( I ) > {t}_{max , ( N - 1 )} ( I ) . \qquad ( 5 )$$

The following equations guarantee that this criterion is met.

$${t}_{min , N} ( I ) = {t}_{max , ( N - 1 )} ( I ) + {T}_{space} \qquad ( 6 )$$

$$∴ {t}_{n o m , N} ( {I}_{meas - max} ) ( 1 - {T}_{\% tol} ) - {T}_{fix - tol} = {t}_{n o m , ( N - 1 )} ( {I}_{meas - min} ) ( 1 + {T}_{\% tol} ) + {T}_{fix - tol} + {T}_{max - int} + {T}_{space} \qquad ( 7 )$$

This means that for any given digital device with coordination number N where N>1, the nominal clearing time t_{nom,N}(I) is:

$$( 8 )$$

$${t}_{n o m , N} ( I ) = \frac{{T}_{space} + {t}_{nom , N - 1 )} ( \frac{1 + {I}_{\% tol}}{1 + {I}_{\% tol}} I ) ( 1 + {T}_{\% tol} ) + 2 {T}_{fix - tol} + {T}_{max - int}}{( 1 - {T}_{\% tol} )} .$$

In equation (8), the nominal clearing time t_{nom,(N-1)} is the nominal clearing time for the downstream digital device. When the coordination number N=1, there are no downstream digital devices, and the digital device must only coordinate with the TCC curve of its largest downstream fuse so that:

$${t}_{min , 1} ( I ) > {t}_{max , fuse} ( I ) , \qquad ( 9 )$$

where t_{max,fuse} is the maximum clearing time of the largest downstream fuse on the network.

$$∴ {t}_{min , 1} ( {I}_{meas - max} ) = {t}_{max , fuse} ( I ) + {T}_{space} \qquad ( 10 )$$

$$∴ {t}_{n o m , 1} ( {I}_{meas - max} ) ( 1 - {T}_{\% tol} ) - {T}_{fix - tol} = {t}_{max , fuse} ( I ) + {T}_{space} \qquad ( 11 )$$

Therefore, for any digital device with coordination number N=1, the nominal clearing time t_{nom,1}(I) is:

$${t}_{n o m , 1} ( I ) = \frac{{T}_{space} + {t}_{max , fuse} ( I / ( 1 + {I}_{\% tol} ) ) + {T}_{fix - tol}}{( 1 - {T}_{\% tol} )} . \qquad ( 12 )$$

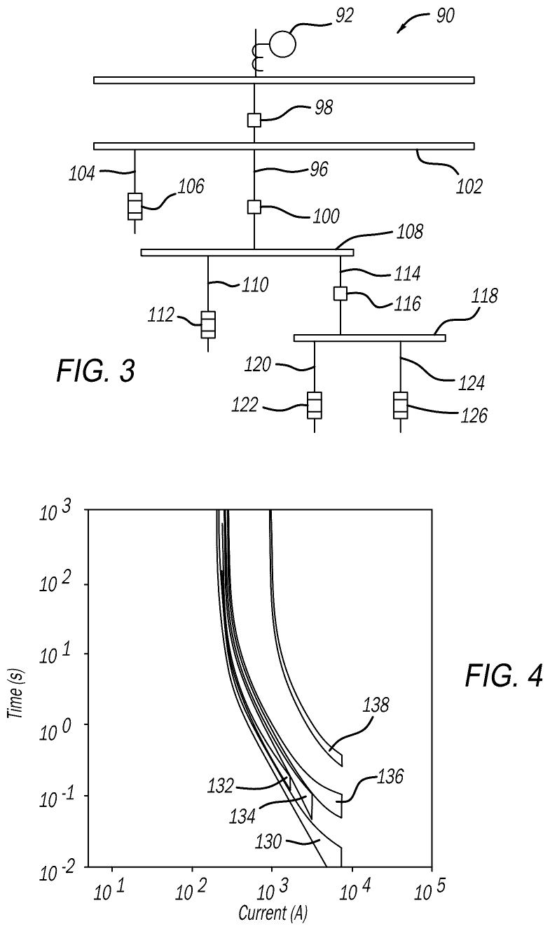

FIG. 3 is a schematic type diagram of a power distribution network 90 used for the discussion below, and includes a configuration of digital devices for a maximum coordination number of 4 similar to the network 10. A circuit breaker 92 is provided at the head of a feeder 96 and two reclosers 98 and 100 are provided on the feeder 96. A lateral 102 is tapped off of the feeder 96 and a distribution line 104 including a fuse 106 is tapped off of the lateral 102. A lateral 108 is also tapped off of the feeder 96 and a distribution line 110 including a fuse 112 is tapped off of the lateral 108. A line 114 is also tapped off of the lateral 108 and includes a recloser 116. A lateral 118 is tapped off of the line 114 and a distribution line 120 including a fuse 122 and a distribution line 124 including a fuse 126 are tapped off of the lateral 118. In this configuration, the recloser 116 has coordination number 1, the recloser 100 has coordination number 2, the recloser 98 has coordination number 3 and the circuit breaker 92 has coordination number 4.

FIG. 4 is a logarithmic graph with current in amps on the horizontal axis and time in seconds on the vertical axis showing the TCC curves of the various devices in the network 90 that were determined using the known curve-stacked coordination scheme. Particularly, the graph shows a TCC curve 130 for each of the fuses 106, 112, 122 and 126, a TCC curve 132 for the recloser 116, a TCC curve 134 for the recloser 100, a TCC curve 136 for the recloser 98 and a TCC curve 138 for the circuit breaker 92. Each of the curves 132-138 has a certain width where a left side of the curve is the minimum trip time of the particular device and the right side of the curve is the maximum clearing time of the particular device. The shape and location of the TCC curve 130 for the fuses 106, 112, 122 and 126 is limited by the materials that are used. The location of the TCC curve 138 for the circuit breaker 92 is determined by when damage might start occurring to the equipment by exposure to the fault current, and therefore cannot be too far to the right. Therefore, the number of TCC curves that can be provided between the TCC curve 130 and the TCC curve 138 is limited.

The shape and location of the TCC curves 130-138 for this particular example are designed so that the higher the fault current, the faster the device will operate and the farther the device is downstream from the source the faster it will operate. Thus, if a fault occurs downstream of any of the fuses 106, 112, 122 and 126, then the particular fuse will operate first. If the fault is between the recloser 116 and the fuses 122 and 126, then the recloser 116 will operate before the reclosers 98 and 100 and the circuit breaker 92. If the fault is between the recloser 100 and the fuse 112 and the recloser 116, then the recloser 100 will operate before the recloser 98 and the circuit breaker 92. If the fault is between the recloser 98 and the fuse 106 and the recloser 100, then the recloser 98 will operate before the circuit breaker 92. If the fault is upstream of the recloser 98, then the circuit breaker 92 will operate. Further, the TCC curves 130-138 are designed so that they are stacked close together, where the minimum trip time of one device is far enough from the maximum clearing time of the previous device.

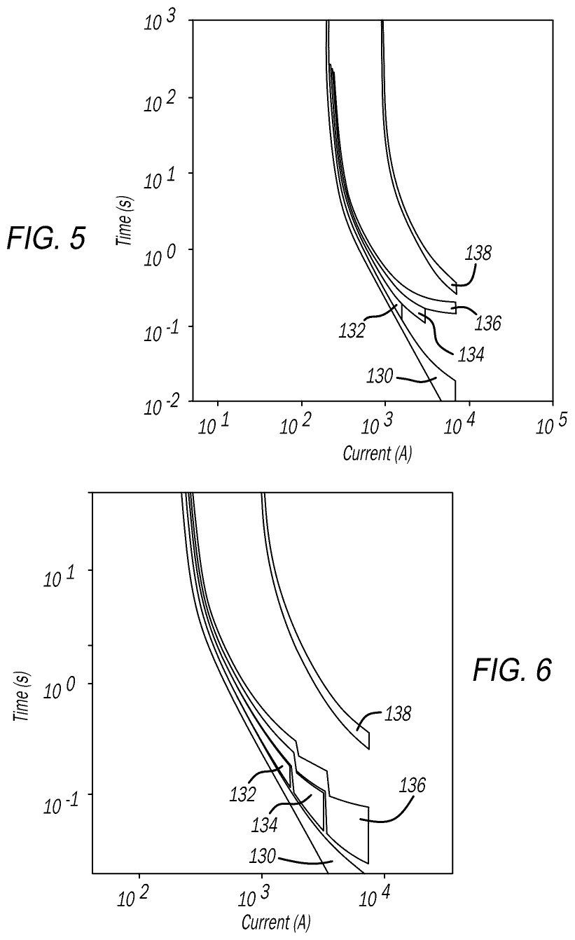

FIG. 5 is a logarithmic graph with current in amps on the horizontal axis and time in seconds on the vertical axis showing the TCC curves 130-138 whose shape and position have been adjusted using the proposed automated tightly-stacked coordination scheme to calculate the nominal clearing time t_{nom,N}(I) of the digital device using equation (8) or (12) as discussed above. As is apparent, the TCC curves 132-136 are more tightly packed together in FIG. 5 than they are in FIG. 4 as a result of using the coordination number, the digital device tolerances and the constant time buffer T_{space} in the manner as discussed above.

One common practice in the art is for distribution engineers to perform fault studies on their system. A fault study provides information about the maximum available fault current possible at each point in the network. The available fault current is always highest right outside the substation where the impedance between the source and the fault is minimal, and lowest at the farthest points from the substation because of the line impedance contribution to the overall source-to-fault impedance. This information can be used to significantly improve the speed of upstream devices at higher current levels. If the maximum available fault current I_{maxAvail}(N−i) of the downstream digital devices is provided, where i is each integer from 1 to N−1, then the nominal clearing time t_{nom,N}(I) to operate from equation (8) can be significantly improved.

When

$$I \geq {I}_{maxAvail} ( N - 1 ) ( \frac{1 + {I}_{\% tol}}{1 - {I}_{\% tol}} ) ,$$

equation (12) can be used to calculate the nominal clearing time t_{nom,N}(I), where t_{nom,1}(I) would be t_{nom,N}(I). Otherwise, equation (8) can continue to be used to calculate the nominal clearing time t_{nom,N}(I). This can be summarized as, where N≥2:

$$( 13 )$$

$${t}_{n o m , N} ( I ) = \{ \begin{matrix}\frac{\begin{matrix}{T}_{space} + {t}_{max , fuse} ( I / ( 1 + {I}_{\% tol} ) ) + \\ {T}_{fix - tol}\end{matrix}}{1 - {T}_{\% tol}} , & I \geq {I}_{maxAvail} ( N - 1 ) ( \frac{1 + {I}_{\% tol}}{1 - {I}_{\% tol}} ) \\ \frac{\begin{matrix}{T}_{space} + {t}_{nom , N - 1 )} ( \frac{1 - {I}_{\% tol}}{1 + {I}_{\% tol}} I ) ( 1 + {T}_{\% tol} ) + \\ 2 {T}_{fix - tol} + {T}_{max - int}\end{matrix}}{1 - {T}_{\% tol}} , & else\end{matrix}$$

When coordinating with a downstream digital device, the maximum available fault current should be considered slightly higher to accommodate the tolerances of the digital device with coordination number N and each device will further benefit from the speed improvement calculated by each downstream device at that device's downstream available fault current.

FIG. 6 is a logarithmic graph with current in amps on the horizontal axis and time in seconds on the vertical axis showing the TCC curves 130-138 whose shape and position have been adjusted using the proposed automated tightly-stacked coordination scheme disclosed herein of the devices in the network 90 with the speed improvement by considering maximum available fault currents for the digital devices. Each digital device after the maximum available fault current of its downstream device could operate faster, leading to the stair shape TCC curves 132-136 in FIG. 6. Table 1 below identifies the tolerances and time constants used to generate the graph shown in FIGS. 5 and 6.

TABLE 1

| I_{% tol} | 2% | |
|---|---|---|
| T_{% tol} | 2% | |
| T_{fix-tol} | 8.3333 | ms |
| T_{space} | 5 | ms |
| Tₘₐₓ₋ᵢₙₜ | 35 | ms |

One of the main advantages of the proposed automated tightly-stacked TCC coordination scheme compared to the known curve-stacked coordination is that in the proposed scheme there is no need to search for a specific curve among a set of defined curves for coordination. In the known curve-stacked coordination scheme, the design engineer needs to dedicate time and effort to find the best curves that provide the fastest response. In the proposed automated tightly-stacked TCC coordination scheme, the TCC curves are calculated automatically based on formulas that are obtained as described above. Since the TCC curves 130-138 are not constrained to be selected among a set of predefined TCC curves, the TCC curves 132-136 are tightly stacked together as shown in FIG. 6. As a result, the speed of operation improves compared to the known curve-stacked coordination scheme. Moreover, because the TCC curves 132-136 are more tightly stacked, more TCC curves can potentially fit between the fuse TCC curve 130 and the circuit breaker TCC curve 138 so it can improve segmentation.

The known curve-stacked coordination scheme can be improved with communications between the devices, sometimes referred to as a blocking scheme. In the known communications enhanced curve-stacked coordination scheme, the downstream devices send a flag to the upstream devices when they sense a fault. If an upstream device receives a flag, it knows not to operate. If it does not receive a flag within the communication latency time, then the upstream device can determine that the fault is within its zone of protection and it can operate after waiting for the largest downstream fuse to operate first. If all of the devices in the line segment have communications with each other, the known communications enhanced curve-stacked coordination scheme could use faster TCC curves compared to the known curve-stacked coordination scheme without communications. Using communications enhanced curve-stacked coordination, the minimum trip time tₘᵢₙ(I) for the digital device with coordination number N is calculated as:

$${t}_{min , N} ( I ) = max ( {t}_{max , fuse} ( I ) , {t}_{com {ms}_{L}} ) . \qquad ( 14 )$$

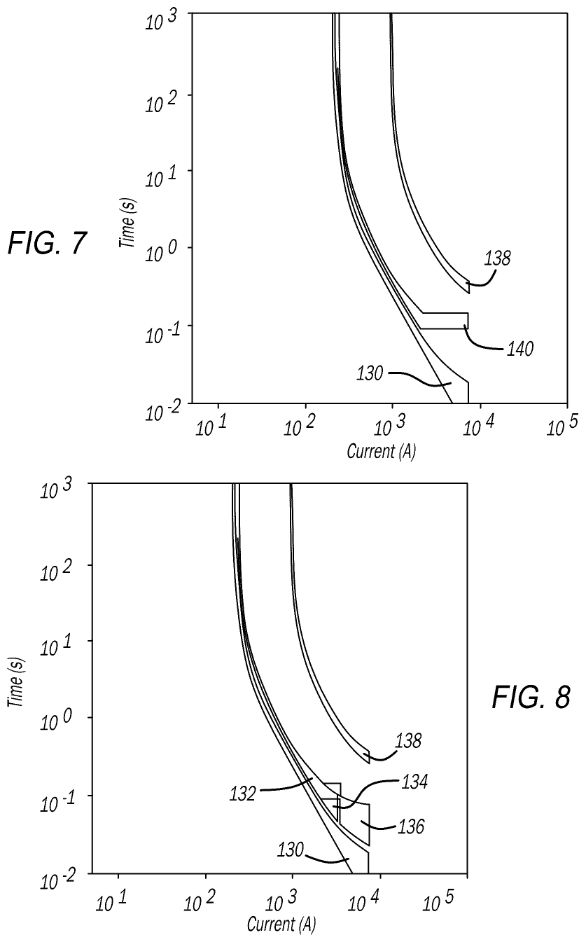

FIG. 7 is a logarithmic graph with current in amps on the horizontal axis and time in seconds on the vertical axis showing the TCC curves when using the known communications enhanced curve-stacked coordination scheme of the various devices in the network 90. For this scheme, all of the reclosers 98, 100 and 116 have the same TCC curve 140.

A communications enhanced automated tightly-stacked (CEATS) coordination scheme is proposed herein that provides better response time than the known communications enhanced curve-stacked coordination scheme. More specifically, when the proposed coordination scheme is enhanced by communications between the digital devices, it can improve the speed in higher fault currents compared to the known communications enhanced curve-stacked coordination scheme. Under this scheme the minimum trip time tₘᵢₙ(I) for the digital device with coordination number N is calculated as:

$$( 15 )$$

$${t}_{n o m , N} ( I ) = \{ \begin{matrix}{t}_{min , N} ( I ) = {t}_{max , fuse} ( I ) + {T}_{space} , & I \geq {I}_{maxAvai1} ( N - 1 ) ( \frac{1 + {I}_{\% tol}}{1 - {I}_{\% tol}} ) \\ \begin{matrix}{t}_{min , N} ( I ) = max ( {t}_{max , fuse} ( I ) , min \\ ( {t}_{com {ms}_{L}} , {t}_{max , N - 1 )} ( I ) ) ) + {T}_{space} ,\end{matrix} & else\end{matrix} ,$$

where t_{comms}_{_{L}} is the maximum communication latency.

FIG. 8 is a logarithmic graph with current in amps on the horizontal axis and time in seconds on the vertical axis showing the TCC curves 130-138 whose shape and position have been adjusted based on the proposed CEATS coordination scheme disclosed herein of the digital devices in the network 90 with the communications improvement, where each digital device has its own TCC curve to achieve a faster operating time.

In a system-wide, end-to-end device deployment scheme, there would be no fuse-like devices. Therefore, the most downstream device (typically transformer protective devices) would be set to use a definite time characteristic which detects in time t_{d-xfrm} and interrupts/arcs in time t_{max_int-xfrm}. This enables even more drastic speed improvements.

The operational description for digital devices up to this point has described a fuse-blowing scheme. However, the digital devices could also be programmed to operate in a fuse-saving mode. In one example of this implementation, the digital devices with coordination number 1 would operate on an instantaneous trip characteristic, and the other devices could coordinate with that characteristic, essentially operating on a definite time characteristic. Fuse-saving schemes suffer from an inability to actually save a fuse at high current levels due to how quickly fuses can melt at high current levels. To improve upon this situation, intelligent fuse-saving can be used. In intelligent fuse saving, if the current is high and the digital device cannot trip faster than a fuse's minimum melt time, the digital device does not attempt to save the fuse. At these high currents, the digital device operates at the speed set by the originally described coordination method. At lower currents where the digital devices can operate faster than the fuse, the device will fuse-save by operating on the instantaneous or definite time characteristic.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for providing fault protection and coordination between a plurality of fault interrupting devices in a power distribution network, the fault interrupting devices being operable to open to clear a fault, the method comprising:
assigning a coordination number to each particular fault interrupting device that are not fuse-like devices depending on where the particular fault interrupting device is in the network and what other fault interrupting devices are downstream of the particular fault interrupting device, where the assigned coordination number to the particular fault interrupting device is equal to the largest coordination number of any downstream fault interrupting device plus one;
calculating a time-current characteristic (TCC) curve for the fault interrupting devices having the lowest coordination number based on a TCC curve of a fuse-like device downstream of the fault interrupting device having the lowest coordination number and tolerances of the fault interrupting device having the lowest coordination number; and
sequentially calculating a TCC curve for the fault interrupting devices having the next lowest coordination number based on the TCC curves of the fault interrupting devices having a lower coordination number and tolerances of the fault interrupting device having the next lowest coordination number until all of the fault interrupting devices having a coordination number have a TCC curve.

2. The method according to claim 1 wherein assigning a coordination number includes assigning a coordination number 1 to the particular fault interrupting device if there are no downstream fault interrupting devices that are not fuse-like devices.

3. The method according to claim 1 wherein assigning a coordination number includes automatically assigning a coordination number to each fault interrupting device using available data.

4. The method according to claim 3 wherein the data is geographic information system (GIS) data.

5. The method according to claim 1 wherein the tolerances include a current sensor tolerance as a percentage of a true measured current, a nominal time tolerance as a percentage of a nominal clearing time for a fault interrupting device to send an open command when measuring current, a fixed time tolerance, and a maximum interruption/arcing time of the fault interruption device.

6. The method according to claim 5 wherein calculating a TCC curve of the fault interrupting devices includes calculating a minimum measured current based on the true measured current and the sensor tolerance, calculating a maximum measured current based on the true measured current and the sensor tolerance, defining a minimum time for the particular fault interrupting device to clear the fault as a function of the nominal clearing time, the maximum measured current and the fixed and nominal time tolerances, defining a maximum time for the particular fault interrupting device to clear the fault as a function of the nominal clearing time, the minimum measured current, the fixed and nominal time tolerance and the maximum interruption/arcing time, and calculating the nominal clearing time of the particular fault interrupting device based on a predetermined buffer time between the minimum time for the particular fault interrupting device to clear the fault and the maximum time for a downstream fault interrupting device to clear the fault, the nominal clearing time for the downstream fault interrupting device to clear the fault, the sensor tolerance, the nominal time tolerance, the fixed time tolerance and the maximum interruption/arcing time.

7. The method according to claim 6 wherein the buffer time is 5 ms.

8. The method according to claim 5 wherein the nominal clearing time of a fault interrupting device having the lowest coordination number is calculated based on a predetermined buffer time between the minimum time for the particular fault interrupting device to clear the fault and the maximum time for a downstream fault interrupting device to clear the fault, a maximum clearing time of a downstream fuse, the sensor tolerance, the nominal time tolerance and the fixed time tolerance.

9. The method according to claim 8 wherein if a maximum available fault current of a downstream fault interrupting device is provided, then when the measured current is greater than the maximum available fault current of the downstream fault interrupting device, the nominal clearing time for the fault interrupting device with any coordination number is calculated based on the predetermined buffer time, the maximum clearing time of a downstream fuse, the sensor tolerance, the nominal time tolerance and the fixed time tolerance.

10. The method according to claim 6 wherein if the fault interrupting devices are in communication with each other, then a minimum trip time of a particular fault interrupting device is a function of a maximum fuse clearing time, a maximum communications latency and the maximum clearing time of a downstream fault interrupting device.

11. The method according to claim 1 wherein the fault interrupting devices are reclosers or circuit breakers.

12. A system for providing fault protection and coordination between a plurality of fault interrupting devices in a power distribution network, the fault interrupting devices being operable to open to clear a fault, the system comprising:
a controller including at least one processor and a memory device storing data and executable code that, when executed, causes the at least one processor to:
assign a coordination number to each particular fault interrupting device that are not fuse-like devices depending on where the particular fault interrupting device is in the network and what other fault interrupting devices are downstream of the particular fault interrupting device, where the assigned coordination number to the particular fault interrupting device is equal to the largest coordination number of any downstream fault interrupting device plus one;
calculate a time-current characteristic (TCC) curve for the fault interrupting devices having the lowest coordination number based on a TCC curve of a fuse-like device downstream of the fault interrupting device having the lowest coordination number and tolerances of the fault interrupting device having the lowest coordination number; and
sequentially calculate a TCC curve for the fault interrupting devices having the next lowest coordination number based on the TCC curves of the fault interrupting devices having a lower coordination number and tolerances of the fault interrupting device having the next lowest coordination number until all of the fault interrupting devices having a coordination number have a TCC curve.

13. The system according to claim 12 wherein the at least one processor assigns a coordination number 1 to the particular fault interrupting device if there are no downstream fault interrupting devices that are not fuse-like devices.

14. The system according to claim 12 wherein the tolerances include a current sensor tolerance as a percentage of a true measured current, a nominal time tolerance as a percentage of a nominal clearing time for a fault interrupting device to send an open command when measuring current, a fixed time tolerance, and a maximum interruption/arcing time of the fault interruption device.

15. The system according to claim 14 wherein the at least one processor calculates a TCC curve of the fault interrupting devices in a manner that includes calculating a minimum measured current based on the true measured current and the sensor tolerance, calculating a maximum measured current based on the true measured current and the sensor tolerance, defining a minimum time for the particular fault interrupting device to clear the fault as a function of the nominal clearing time, the maximum measured current and the fixed and nominal time tolerance, defining a maximum time for the particular fault interrupting device to clear the fault as a function of the nominal clearing time, the minimum measured current, the fixed and nominal time tolerance and the maximum interruption/arcing time, and calculating the nominal clearing time of the particular fault interrupting device based on a predetermined buffer time between the minimum time for the particular fault interrupting device to clear the fault and the maximum time for a downstream fault interrupting device to clear the fault, the nominal clearing time for the downstream fault interrupting device to clear the fault, the sensor tolerance, the nominal time tolerance, the fixed time tolerance and the maximum interruption/arcing time.

16. The system according to claim 14 wherein the at least one processor calculates the nominal clearing time of a fault interrupting device having the lowest coordination number based on a predetermined buffer time between the minimum time for the particular fault interrupting device to clear the fault and the maximum time for a downstream fault interrupting device to clear the fault, a maximum clearing time of a downstream fuse, the sensor tolerance, the nominal time tolerance and the fixed time tolerance.

17. The system according to claim 16 wherein if a maximum available fault current of a downstream fault interrupting device is provided, then when the measured current is greater than the maximum available fault current of the downstream fault interrupting device the at least one processor calculates the nominal clearing time for the fault interrupting device with any coordination number based on the predetermined buffer time, the maximum clearing time of a downstream fuse, the sensor tolerance, the nominal time tolerance and the fixed time tolerance.

18. The system according to claim 15 wherein if the fault interrupting devices are in communication with each other, then a minimum trip time of a particular fault interrupting device is a function of a maximum fuse clearing time, a maximum communications latency and the maximum clearing time of a downstream fault interrupting device.

19. A method for providing fault protection and coordination between a plurality of fault interrupting devices in a power distribution network, the fault interrupting devices being operable to open to clear a fault, the method comprising:
assigning a coordination number to each particular fault interrupting device depending on where the particular fault interrupting device is in the network and what other fault interrupting devices are downstream of the particular fault interrupting device, where the assigned coordination number to the particular fault interrupting device is equal to the largest coordination number of any downstream fault interrupting device plus one;
calculating a time-current characteristic (TCC) curve for the fault interrupting devices having the lowest coordination number based tolerances of the fault interrupting device having the lowest coordination number; and
sequentially calculating a TCC curve for the fault interrupting devices having the next lowest coordination number based on the TCC curves of the fault interrupting devices having a lower coordination number and tolerances of the fault interrupting device having the next lowest coordination number until all of the fault interrupting devices having a coordination number have a TCC curve.

20. The method according to claim 19 wherein the tolerances include a current sensor tolerance as a percentage of a true measured current, a nominal time tolerance as a percentage of a nominal clearing time for a fault interrupting device to send an open command when measuring current, a fixed time tolerance, and a maximum interruption/arcing time of the fault interruption device.
